(19) United States
(12) Patent Application Publication
(10) Pub. No.: US 2017/0122672 A1
(43) Pub. Date: May 4, 2017

(54) VAPOR CHAMBER AND MANUFACTURING METHOD THEREOF

(71) Applicant: TAIWAN MICROLOOPS CORP., New Taipei City (TW)

(72) Inventor: Chun-Hung LIN, New Taipei City (TW)

(21) Appl. No.: 14/925,617

(22) Filed: Oct. 28, 2015

(51) Int. Cl. F28D 15/04; B23P 15/26

(52) U.S. Cl. CPC F28D 15/04; B23P 15/26; B23P 2700/09

(57) ABSTRACT

In a vapor chamber and a manufacturing method thereof, the vapor chamber includes a lower metal case, an upper metal case, a plurality of support posts and a working fluid; the upper metal case is tightly engaged with the lower metal case, and a chamber is formed between the upper metal case and the lower metal case; the support posts are accommodated in the chamber and disposed between the upper metal case and the lower metal case, each of the support posts includes a hollow metal member and a capillary structure disposed inside the hollow metal member, and one end of the hollow metal member is soldered and fastened on the upper metal case; and the working fluid is filled in the chamber. Accordingly, advantages of simplifying manufacturing process, shortening manufacturing time and ensuring the quality of the vapor chamber to be stable can be achieved.

### BACKGROUND OF THE INVENTION

Field of the Invention

The present invention relates to a vapor chamber, especially to a vapor chamber used in an electronic component generating heat and a manufacturing method thereof.

Description of Related Art

With the increasing calculation speed of an electronic component, massive amount of heat is generated. For effectively dissipating the massive amount of heat, the skilled people in the art have developed a vapor chamber which has good heat conducting performance and has been wildly applied. However, there are still rooms to improve the heat conducting performance, the production cost and the manufacturing process for the vapor chamber.

A manufacturing method of a conventional vapor chamber is to adhere an upper capillary tissue on an upper case then convey into a heater for thermal combination, then adhere a lower capillary tissue on a lower case then convey into a heater for thermal combination, a support structure is disposed on the lower case, lastly the upper case is engaged with the lower case then conveyed into a heater for thermal combination.

However, for the manufacturing method of the conventional vapor chamber and the manufactured product, a heat conducting effect is provided but following disadvantages still exist: during the manufacturing process, the heater has be to be used for multiple times for thermal combination, so the process is complicated and a lot of manufacturing time and costs are required, and after multiple times of heating and cooling, the capillary tissue and the cases may be irregularly deformed and the capillary tissue may be detached, thereby causing poor heat conducting performance. Accordingly, the above-mentioned disadvantages shall be improved.

### SUMMARY OF THE INVENTION

The present invention is to provide a vapor chamber and a manufacturing method thereof, which have advantages of simplifying manufacturing process, shortening manufacturing time and ensuring the quality of the vapor chamber to be stable.

Accordingly, the present invention provides a manufacturing method of a vapor chamber, which includes the steps of: a step a) preparing an upper metal case and a plurality of hollow metal members, and forming an inner wall on the upper metal case; a step b) fastening each of the hollow metal members on the inner wall with a soldering means; a step c) a capillary structure being filled in the hollow metal member thereby forming a plurality of support posts; a step d) tightly engaging the upper metal case with a lower metal case, and a chamber being formed between the upper metal case and the lower metal case for accommodating the support posts; and a step e) filling a working fluid in the chamber and a gas discharging and sealing operation being processed.

Accordingly, the present invention provides a vapor chamber, which includes a lower metal case, an upper metal case, a plurality of support posts and a working fluid; the upper metal case is tightly engaged with the lower metal case, and a chamber is formed between the upper metal case and the lower metal case; the support posts are accommodated in the chamber and disposed between the upper metal case and the lower metal case, each of the support posts includes a hollow metal member and a capillary structure disposed inside the hollow metal member, and one end of the hollow metal member is soldered and fastened on the upper metal case; and the working fluid is filled in the chamber.

Advantages achieved by the present invention are as follows: the returning speed of the working fluid is able to be increased through the capillary structure being in contact with the inner wall of the substrate; and the hollow metal member is formed as a conical tube thereby allowing metal powders to be filled in and enabling the structure thereof to be firm and compact.

### BRIEF DESCRIPTION OF DRAWING

FIG. 1 is a flowchart illustrating a manufacturing method of a vapor chamber according to the present invention;

FIG. 2 is a schematic view showing the assembly of an upper metal case and hollow metal members according to a first embodiment of the present invention;

FIG. 3 is a schematic view showing the assembly of the upper metal case and support posts according to the first embodiment of the present invention;

FIG. 4 is a perspective exploded view according to the first embodiment of the present invention;

FIG. 5 is a cross sectional view showing the assembly according to the first embodiment of the present invention;

FIG. 6 is a cross sectional view showing the assembly according to a second embodiment of the present invention;

FIG. 7 is a cross sectional view showing the assembly according to a third embodiment of the present invention;

FIG. 8 is a cross sectional view showing the assembly according to a fourth embodiment of the present invention; and

FIG. 9 is a cross sectional view showing the assembly according to a fifth embodiment of the present invention.

### DETAILED DESCRIPTION OF THE INVENTION

Preferred embodiments of the present invention will be described with reference to the drawings.

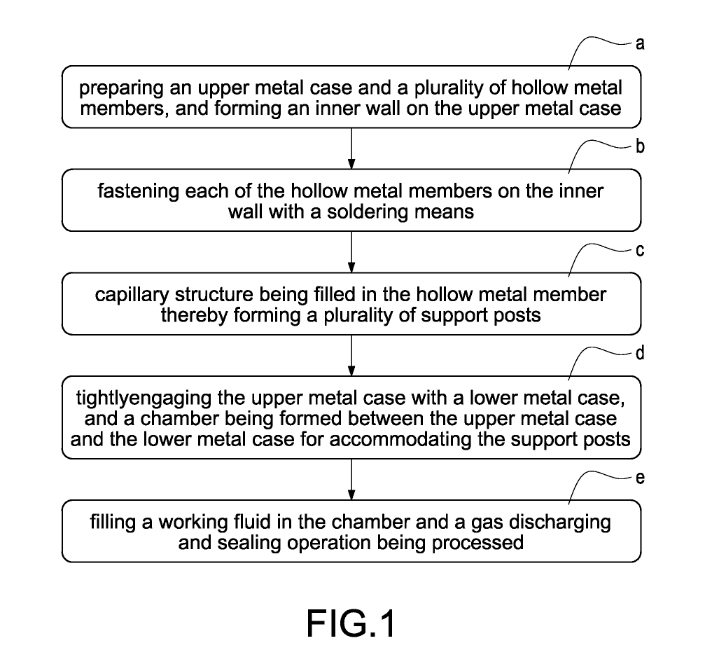

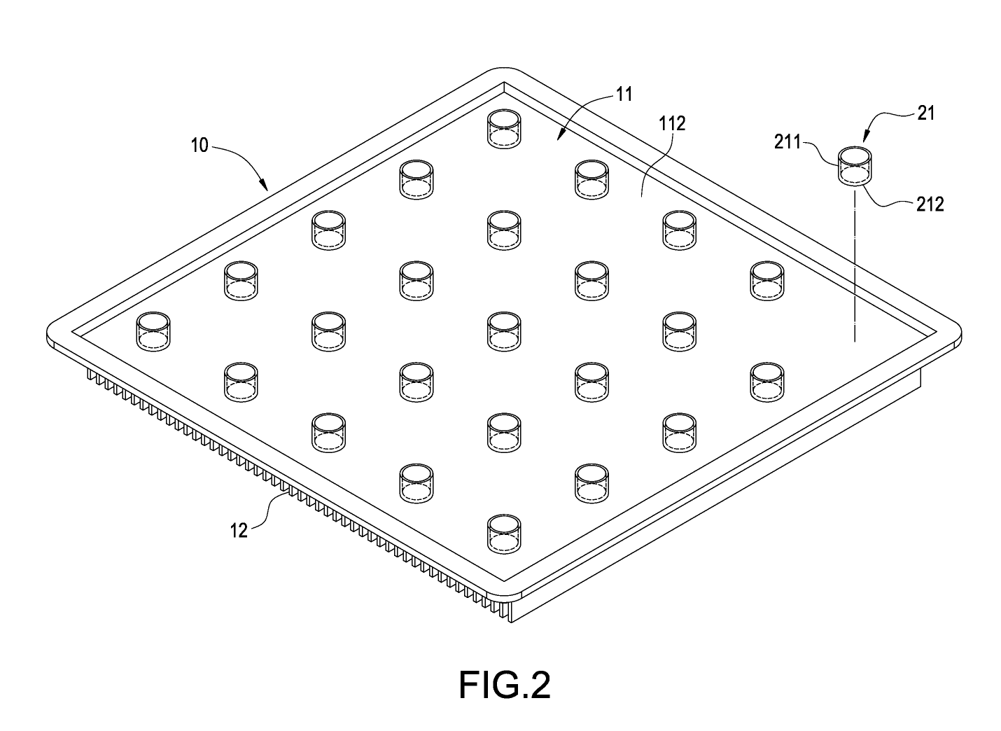

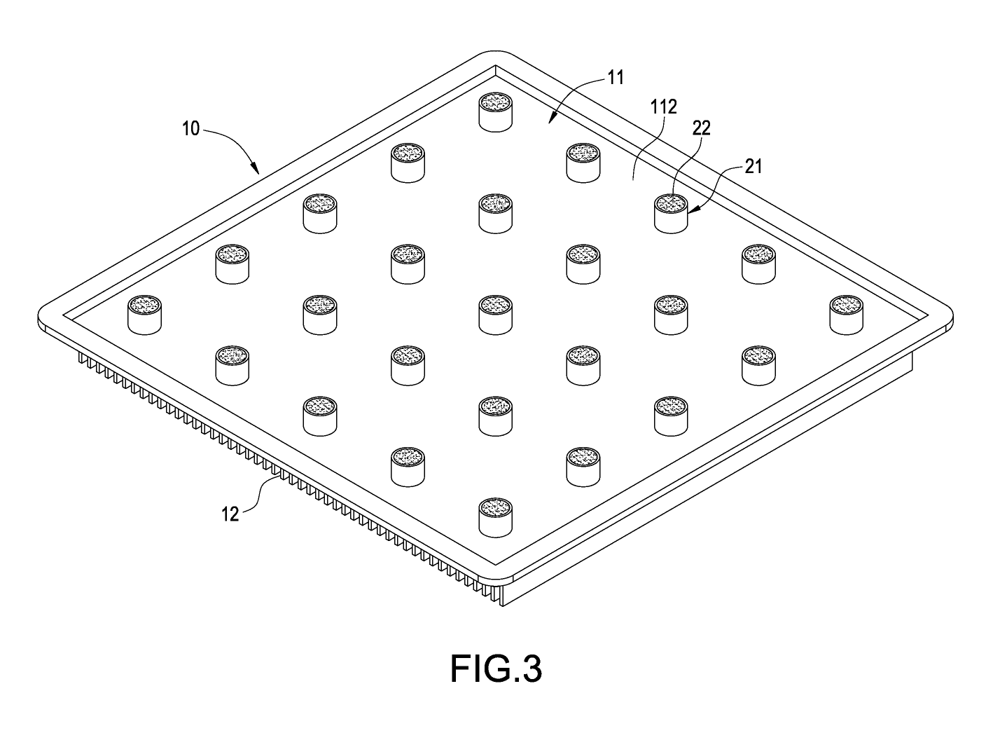

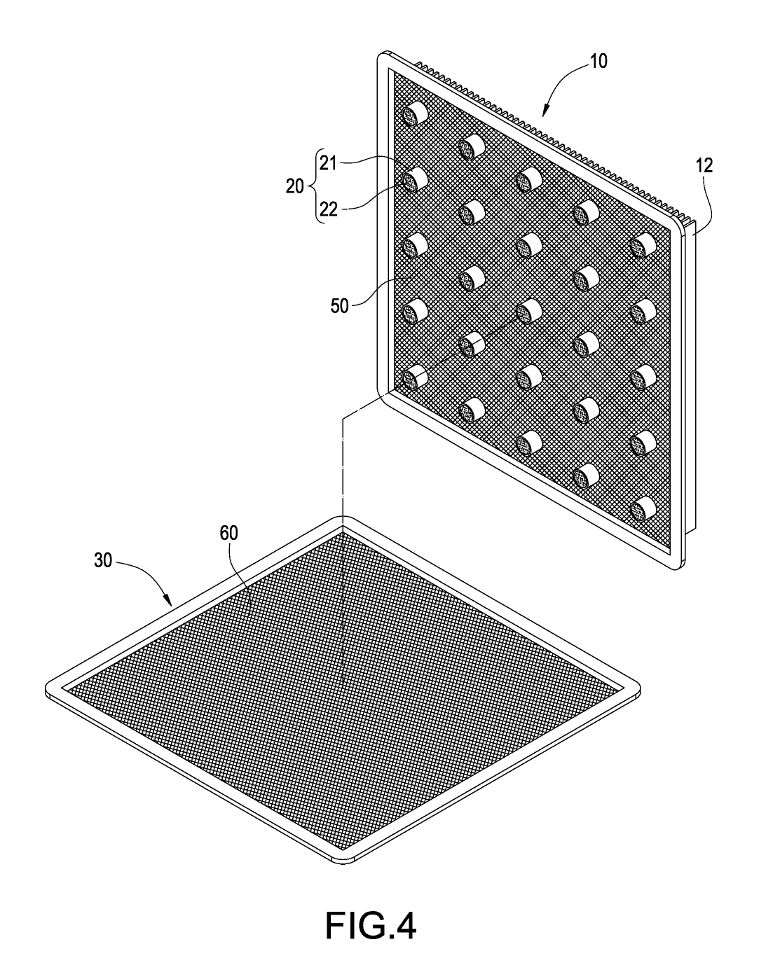

Please refer from FIG. 1 to FIG. 5, the present invention provides a manufacturing method of a vapor chamber, which includes the steps of:

a step a) preparing an upper metal case 10 and a plurality of hollow metal members 21,

and forming an inner wall 112 on the upper metal case 10; in this step, the upper metal case 10 can be made of an electric conductive material such as copper, aluminum or an alloy thereof, and the upper metal case 10 mainly includes a rectangular substrate 11 and a plurality of heat dissipation fins 12, the substrate 11 is formed with an outer surface 111 and the inner surface 112 at the back side of the outer surface 111, each of the heat dissipation fins 12 is extended from the outer surface 111 and integrally formed, and the heat dissipation fins 12 can be formed with an extruding or cutting means and arranged with intervals. The hollow metal members 21 can also be made of an electric conductive material such as copper, aluminum or an alloy thereof, according to this embodiment, the hollow metal member 21 includes a round tube 211 and a cover plate 212 covering at one end of the round tube 211.

a step b) fastening each of the hollow metal members 21 on the inner wall 112 with a

soldering means; in this step, the soldering means can be a spot soldering means or a plasma soldering means, the hollow metal member 21 is connected to electrodes of a soldering machine and provided with an electric current, so the hollow metal member 21 is able to be soldered and fastened on the inner wall 112 of the upper metal case 10 because of the maximum resistance generated between the cover plate 212 of the hollow metal member 21 and the inner wall 112 of the upper metal case 10.

a step c) a capillary structure 22 being filled in the hollow metal member 21 thereby forming a plurality of support posts 10; in this step, the capillary structure 22 can be a metal woven net, fiber bundles or metal powders which are respectively filled in the interior of each of the hollow metal members 21 thereby forming the plurality of support posts 20, and each of the support posts 20 is composed of one of the hollow metal members 21 and one of the capillary structures 22 filled in the hollow metal member 21.

a step d) tightly engaging the upper metal case 10 with a lower metal case 30, and a chamber A being formed between the upper metal case 10 and the lower metal case 30 for accommodating the support posts 20; in this step, the lower metal case 30 can also be made of an electric conductive material such as copper, aluminum or an alloy thereof, the upper metal case 10 and the lower metal case 30 are correspondingly stacked and a soldering operation is processed at the periphery thereof so as to form a sealing status, and the support posts 20 are formed in the chamber A defined by the upper metal case 10 and the lower metal case 30.

a step e) filling a working fluid 40 in the chamber A and a gas discharging and sealing operation being processed; is this step, the working fluid 40 can be water filled in the chamber A defined by the upper metal case 10 and the lower metal case 30, and the gas discharging and sealing operation is processed. Accordingly, the manufacturing method of the vapor chamber provided by the present invention is finished.

In addition, the manufacturing method of the vapor chamber provided by the present invention further includes a step a1) processed after the step a), and the step a1) is to fasten an upper capillary tissue 50 on the inner wall 112 with a soldering means; in this step, the upper capillary tissue 50 can be a metal woven net, and a plurality of penetrated holes 51 arranged with intervals are formed in the upper capillary tissue 50 thereby allowing the hollow metal members 21 to be received; wherein, the soldering means can be a spot soldering means or a plasma soldering means. Moreover, the step a1) can also be processed after the step b), after each of the hollow metal members 21 is soldered and fastened on the inner wall 112, the penetrated hole 51 of the upper capillary tissue 50 is sleeved on the hollow metal member 21 then soldered and fastened on the inner wall 112.

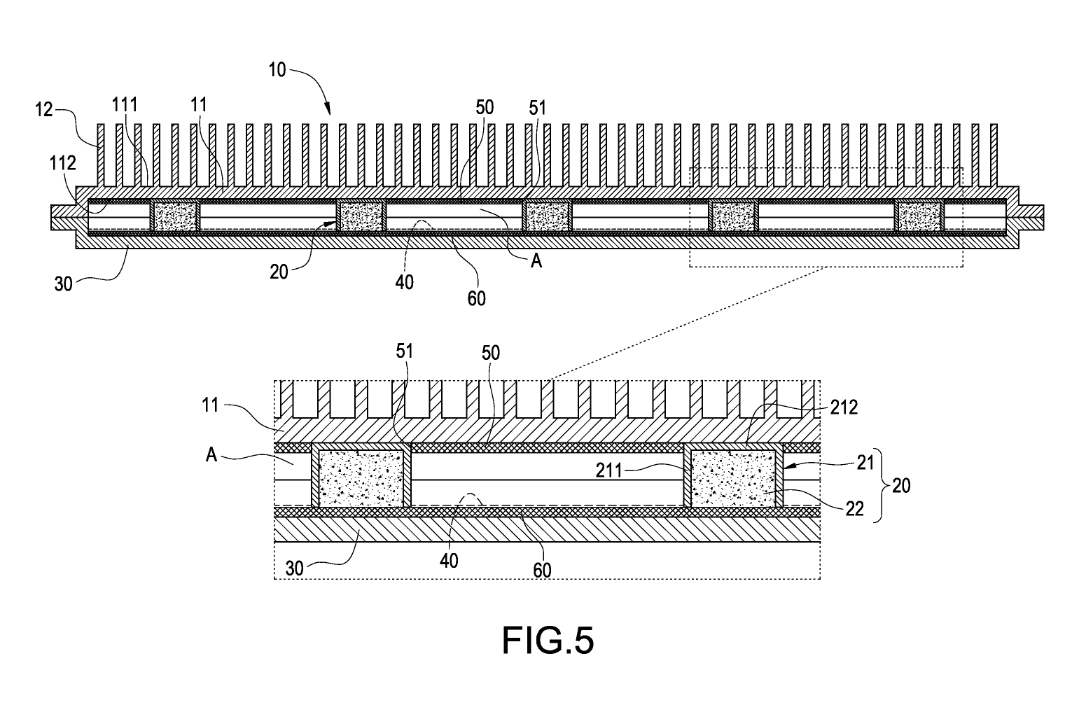

As shown in FIG. 5, a vapor chamber is manufactured through the above-mentioned manufacturing method, and the vapor chamber includes an upper metal case 10, a plurality of support posts 20, a lower metal case 30 and a working fluid 40; the upper metal case 10 is tightly engaged with the lower metal case 30, and a chamber A is formed between the upper metal case 10 and the lower metal case 30; the support posts 20 are accommodated in the chamber A and disposed between the upper metal case 10 and the lower metal case 30, each of the support posts 20 includes a hollow metal member 21 and a capillary structure 22 disposed inside the hollow metal member 21, and one end of the hollow metal member 21 is soldered and fastened on an inner wall 112 of the upper metal case 10; and the working fluid 40 is filled in the chamber A.

According to the present invention, the vapor chamber further includes an upper capillary tissue 50, the upper capillary tissue 50 can be a metal woven net arranged and soldered on the inner wall 112 of the upper metal case 10, a plurality of penetrated holes 51 arranged with intervals are formed in the upper capillary tissue 50 thereby allowing the hollow metal members 21 to be received and accommodated.

According to the present invention, the vapor chamber further includes a lower capillary tissue 60, the lower capillary tissue 60 can be a metal woven net arranged and soldered on an inner wall of the lower metal case 30, and the lower capillary tissue 60 is clamped between the bottom end of each of the support posts 20 and the inner wall of the lower metal case 30.

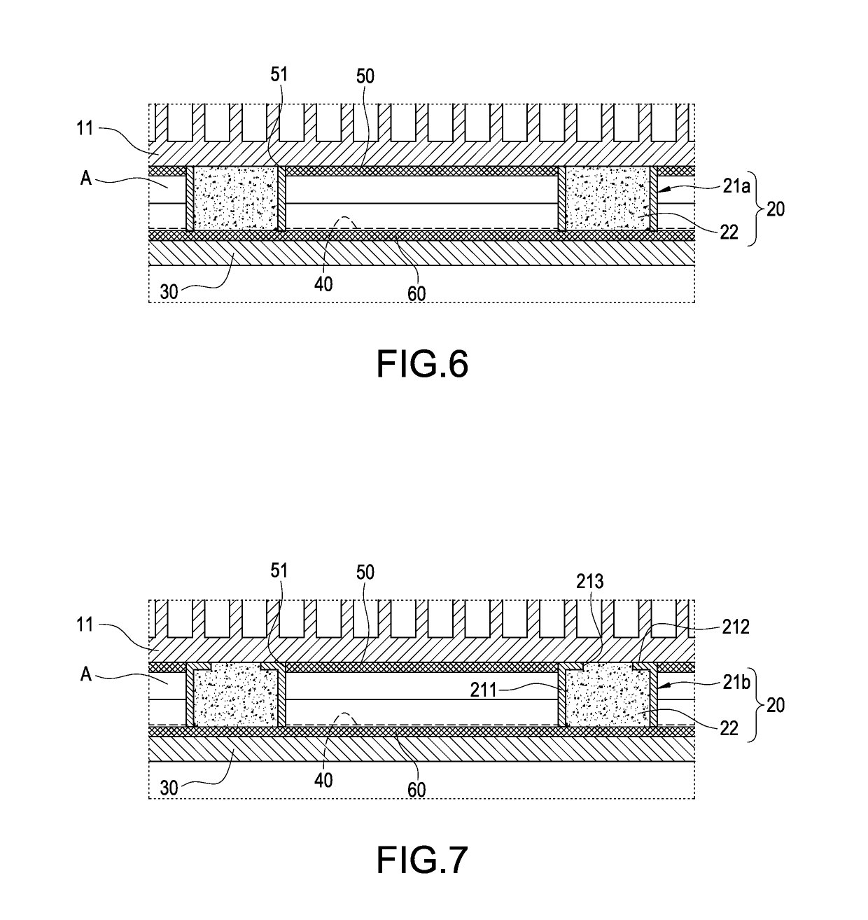

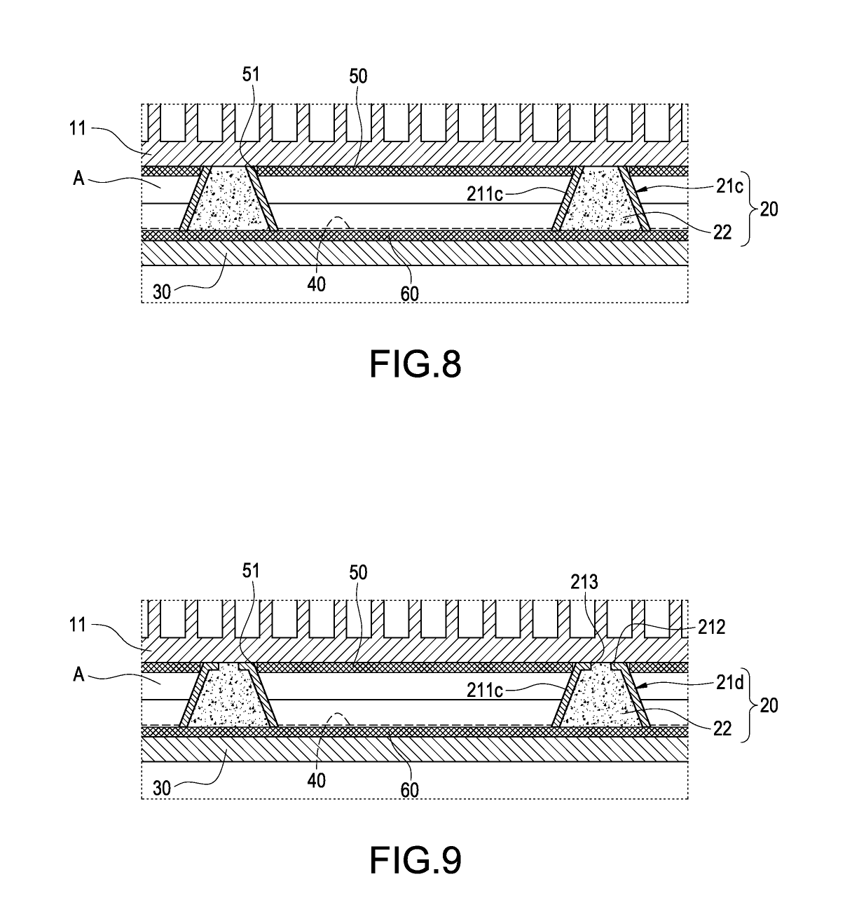

Referring from FIG. 6 to FIG. 9, the configuration of the support post 20 of the vapor chamber provided by the present invention can be different from what has been disclosed in the previous embodiment. As shown in FIG. 6, a hollow metal member 21a is formed as a round tube, and the top end of the capillary structure 22 is in contact with the inner wall 112 of the substrate 11. As shown in FIG. 7, a hollow metal member 21b includes a round tube 211, a cover plate 212 connected at one end of the round tube 211 and a through hole 113 formed on the cover plate 212, wherein the top end of the capillary structure 22 is protruded out of the through hole 213 for being in contact with the inner wall 112 of the substrate 11. As shown in FIG. 8, a hollow metal member 21c is formed as a conical tube 211c, wherein the top end of the capillary structure 22 is in contact with the inner wall 112 of the substrate 11. And as shown in FIG. 9, a hollow metal member 21d includes a conical tube 211c, a cover plate 212 connected at one end of the conical tube 211c and a through hole 213 formed on the cover plate 212, wherein the top end of the capillary structure 22 is protruded out of the through hole 213 for being in contact with the inner wall 112 of the substrate 11.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A manufacturing method of a vapor chamber, including:
step a) preparing an upper metal case and a plurality of hollow metal members, and forming an inner wall on the upper metal case;
step b) fastening each of the hollow metal members on the inner wall with a soldering means;
step c) a capillary structure being filled in the hollow metal member thereby forming a plurality of support posts;
step d) tightly engaging the upper metal case with a lower metal case, and a chamber being formed between the upper metal case and the lower metal case for accommodating the support posts; and
step e) filling a working fluid in the chamber and a gas discharging and sealing operation being processed.

2. The manufacturing method of the vapor chamber according to claim 1, wherein in the step a), the upper metal case includes a substrate and a plurality of heat dissipation fins, the substrate is formed with an outer surface at the back side of the inner wall, and the heat dissipation fin is extended from the outer surface and integrally formed.

3. The manufacturing method of the vapor chamber according to claim 2, wherein in the step b), the soldering means is a spot soldering means or a plasma soldering means.

4. The manufacturing method of the vapor chamber according to claim 1, further including a step a1) processed after the step a), and the step a1) is to fasten an upper capillary tissue on the inner wall with a soldering means.

5. The manufacturing method of the vapor chamber according to claim 1, further including a step a1) processed after the step b), and the step a1) is to fasten an upper capillary tissue on the inner wall with a soldering means.

6. A vapor chamber, including:
a lower metal case;
an upper metal case, tightly engaged with the lower metal case, wherein a chamber is formed between the upper metal case and the lower metal case;
a plurality of support posts, accommodated in the chamber and disposed between the upper metal case and the lower metal case, wherein the support post includes a hollow metal member and a capillary structure disposed inside the hollow metal member, and one end of the hollow metal member is soldered and fastened on the upper metal case; and
a working fluid, filled in the chamber.

7. The vapor chamber according to claim 6, wherein the upper metal case includes a substrate and a plurality of heat dissipation fins, the substrate is formed with an inner wall and an outer surface at the back side of the inner wall, and the heat dissipation fin is extended from the outer surface and integrally formed.

8. The vapor chamber according to claim 7, wherein the hollow metal member includes a round tube and a cover plate covering at one end of the round tube, and the cover plate is fastened on the inner wall.

9. The vapor chamber according to claim 7, wherein the hollow metal member includes a round tube, one end of the round tube is fastened on the inner wall, and the capillary structure is protruded out of the round tube for being in contact with the inner wall.

10. The vapor chamber according to claim 7, wherein the hollow metal member includes a round tube, a cover plate connected at one end of the round tube and a through hole formed on the cover plate, the cover plate is fastened on the inner wall of the substrate, and the capillary structure is protruded out of the through hole for being in contact with the inner wall.

11. The vapor chamber according to claim 7, wherein the hollow metal member includes a conical tube, one end of the conical tube is fastened on the inner wall, and the capillary structure is protruded out of the conical tube for being in contact with the inner wall.

12. The vapor chamber according to claim 7, wherein the hollow metal member includes a conical tube, a cover plate connected at one end of the conical tube and a through hole formed on the cover plate, the cover plate is fastened on the inner wall of the substrate, and the capillary structure is protruded out of the through hole for being in contact with the inner wall.

13. The vapor chamber according to claim 7, further including an upper capillary tissue, wherein the upper capillary tissue is a metal woven net, and a plurality of penetrated holes arranged with intervals are formed in the metal woven net, and the penetrate hole is served to receive and accommodate the support post.

14. The vapor chamber according to claim 13, further including a lower capillary tissue, wherein the lower capillary tissue is disposed in the lower metal case and clamped between the bottom end of each of the support posts and the lower metal case.
